(19) United States
(12) Patent Application Publication
(10) Pub. No.: US 2004/0216162 A1
(43) Pub. Date: Oct. 28, 2004

(54) Distribution of television broadcast network programming to receiving subscribers over dedicated individual RF channels enabling interactive subscriber functions in a wireless cellular telecommunications system

(75) Inventors: Timothy Alan Dietz, Austin, TX (US); Walid M. Kobrosly, Round Rock, TX (US); Nadeem Malik, Austin, TX (US); Avijit Saha, Somers, NY (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY (US)

(21) Appl. No.: 10/422,022

(22) Filed: Apr. 23, 2003

(51) Int. Cl. H04N 7/16

(52) U.S. Cl. 725/62

(57) ABSTRACT

A cellular telecommunications alternative for the distribution of broadcast television for receivers that may be wireless and mobile, or for regions inaccessible to satellites but not yet wired for cablevision. A communications system for the distribution of broadcast television programming by a cellular telecommunications service provider to a plurality of service subscribers through wireless receivers of said subscribers that comprises the combination of apparatus for broadcasting said television programming, and service provider implementations for receiving said broadcasted television programming. This service provider uses cellular means for telecommunicating this television programming to each of the subscribers over a wireless RF channel respectively dedicated to each of said subscribers. There are wireless receiving apparatus at each of the subscribers for receiving said telecommunicated television programming. The wireless receiving apparatus may be mobile and the programming is preferably transmitted over the RF channel in digital form.

### TECHNICAL FIELD

The present invention relates to telecommunications through mobile wireless cellular array systems and particularly to the use of such systems for the wireless distribution of television broadcast network programming to receiving cellular telecommunication system subscribers.

### BACKGROUND OF RELATED ART

With the globalization of business, industry and trade wherein transactions and activities within these fields have been changing from localized organizations to diverse transactions over the face of the world, the telecommunication industries have, accordingly, been expanding rapidly. Wireless telephones and, particularly, cellular telephones have become so pervasive that their world wide number is in the order of hundreds of millions. While the embodiment to be subsequently described relates to cellular telephones. The wireless telephone industry rapid expansion has driven cellular telecommunications in all related wireless industries. Consequently, the principles of the invention would be applicable to any wireless personal communication device and services that could be used to communicate in a cellular telecommunications system. These would include the wide variety of currently available communicating personal palm devices or Personal Digital Assistants (PDAs), that include, for example, Microsoft's WinCE line; the PalmPilot line produced by 3Com Corp.; and International Business Machines Corporation's WorkPad. These devices are comprehensively described in the text, Palm III & PalmPilot, Jeff Carlson, Peachpit Press, 1998. In addition, wireless telecommunication services are expanding into the cellular wireless laptop and notebook personal computers.

Despite the rapid expansion and the proliferation of wireless cellular telephones and networks, the industry is experiencing a deceleration in consumer demand for wireless cellular telecommunications products. As a result, the cellular wireless telecommunications industry is seeking new and expanded uses for its products and business services. One commercial area into which wireless cellular technology could potentially expand is the wireless transmission of standard broadcast network television programming to wireless receiving users. After more than fifty years of network broadcast television program distribution, one might conclude that such broadcast programming is fairly pervasive throughout the world. The traditional line-of-sight television broadcasting has been supplemented and enhanced by satellite and cablevision service providers that capture the conventional line-of-sight broadcasts and enhance and distribute the same via cable and satellite connections to their individual subscribers. However, cablevision requires fixed hardwired connections to the programming subscribers while satellite distribution requires satellite dishes in fixed positions with unblocked lines of sight to earth tracking satellites.

Thus, there may be rural areas with wooded and or mountainous terrain where satellite is not accessible but the population is too sparse to commercially justify hardwired cable networked connections. Also, and most significantly, all three conventional methods of reception of television broadcasting require stationary television reception apparatus.

### SUMMARY OF THE PRESENT INVENTION

The present invention provides a cellular telecommunications alternative for the distribution of broadcast television to receivers that are wireless and mobile. In addition, the broadcast television programming may be transmittable to receiving subscribers in regions inaccessible to satellites but not yet wired for cablevision, i.e. there may be regions around the globe that have a cellular communications infrastructure but not a cablevision one. It should also be noted that there have been recent advances of wireless cellular telecommunications technology that enables the transmission of data having the resolution and size needed to suit standard laptop or notebook sized display screens. Such a trend should enhance the need for the technology of the present invention.

Accordingly, the present invention provides a communications system for the distribution of broadcast television programming by a cellular telecommunications service provider to a plurality of service subscribers through wireless receivers of said subscribers that comprises the combination of apparatus for broadcasting said television programming and service provider means for receiving said broadcasted television programming. This service provider uses cellular means for telecommunicating this television programming to each of the subscribers over a wireless RF channel respectively dedicated to each of said subscribers. There are wireless receiving means at each of the subscribers for receiving said telecommunicated television programming. The wireless receiving means may be mobile and the programming is preferably transmitted over the RF channel in digital form.

In addition, because the broadcast programming is transmitted to individual subscribers over individually dedicated RF channels, subscriber interactive means associated with each individual wireless receiving means may be provided for responding to the received television programming over the wireless dedicated channel over which said television programming is being sent. In addition, the cellular telecommunications service provider also provides the conventional means for telecommunicating personal subscriber communications to and from said wireless receiving means via said wireless dedicated RF channels.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system including a processor unit that provides the telecommunications system of the present invention for the distribution of broadcast television programming by a cellular telecommunications service provider to a plurality of service subscribers through wireless receivers of said subscribers;

FIG. 2 is a block diagram of a generalized data processing system, including a processor unit that may function as the service provider computer control for the cellular wireless distribution of broadcast television programming, as well as the computer control of the wireless receiving apparatus of the present invention;

FIG. 3 is an illustrative flowchart describing the setting up of the elements needed for the program of the invention for the distribution of broadcast television programming by a cellular telecommunications service provider to a plurality of service subscribers through wireless receivers of said subscribers; and

FIG. 4 is a flowchart of an illustrative simplified run of the program set up in FIG. 3.

### DETAILED DESCRIPTION OF THE PREFERRED EMBODIMENT

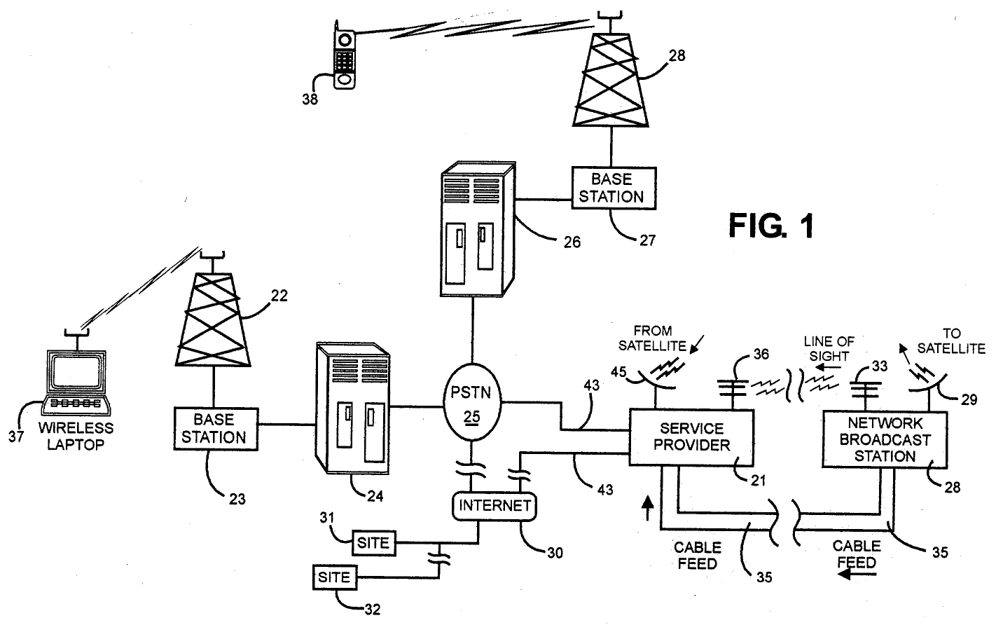

Referring to FIG. 1, there is shown a generalized diagrammatic view of a portion of a cellular telephone network connected into a conventional Public Switched Telephone Network (PSTN) 25 showing channel paths to and from wireless receiving subscriber stations, e.g. cellular display personal digital assistant or cellular telephone 38 or wireless personal computer laptop or notebook computer 37. However, at this point, some general background information on cellular telephone systems should be reviewed in order for the invention to be better understood. The principal forms of telecommunication should be briefly considered. The standard wired telecommunications system, which has been in use world wide for well over 100 years, is the conventional handheld or speaker input wired into a base that, in turn, is wired into a PSTN with wired switched channel paths to and from other telephones or like devices through their bases. These telephones are respectively connected to the PSTN via local switching centers or switching nodes in a fully wired telecommunication system. Conventionally, these switching centers have many telephones connected to each other. The centers operate to control the channel connections, i.e. switch into and out of the PSTN, those calls originated or terminated at telephone stations.

In addition, there have been developed over the past 20 years two major mobile wireless systems: 1) the short range wireless radio frequency (RF) “cordless” telephone system; and 2) the mobile wireless long range RF “wireless” telephone system that has been commercialized primarily as the “cellular” telephone or telecommunications systems.

The cordless telephone is, basically, a combination telephone and RF receiver/transmitter. The cordless phone has a base and a handset. The base is wired through any standard phone jack into the conventional PSTN. The base receives the incoming call as a normal phone line signal, converts the signal into an FM RF signal (preferably digital in present technology) and broadcasts the signal over a short range to the mobile handset that receives the signal and converts it into the analog signal that is heard over the phone. When the user speaks, the handset converts the analog speech signal into an FM RF digital signal that is broadcast back to the base that in turn receives and converts the signal back into the line signal to the PSTN. Thus, the cordless telephone base looks like and operates like a conventional wired phone base as far as the PSTN is concerned. The one thing that the cellular long range communication system has in common with the short range cordless system is that both eventually have a base station that looks and acts like a standard wired telephone base with respect to the PSTN.

Before the cellular wireless phone system was developed, long range mobile wireless phones were relatively rudimentary and were usually in automobiles. There was usually one central tower with about 25 channels available on the tower. The mobile wireless telephone needed a large powerful transmitter, usually in the automobile that had to transmit up to 50 miles. This was too cumbersome for any personal or portable phone. In the cellular telecommunications systems for the mobile wireless telephones and receiving devices, an area such as a city is broken up into small area cells. Each cell is about 10 square miles in area. Each has its base station that has a tower for receiving/transmitting and a base connected into PSTN. Even though a typical carrier is allotted about 1000 frequency channels, the creation of the cells permit extensive frequency reuse so that tens of thousands of people in the city can be using their cellular telecommunications systems simultaneously. Cellular telecommunications systems, particularly those used in the present invention, are now preferably digital with each cell having over 160 available channels for assignment to users. In a large city, there may be hundreds of cells each with its tower and base station. Because of the number of towers and users per carrier, each carrier has a Mobile Telephone Switching Office (MTSO) that controls all of the base stations in the city or region and controls all of the connections to the land based PSTN. When a client cell phone gets an incoming call, MTSO tries to locate what cell the client mobile phone is in. The MTSO then assigns a frequency pair for the call to the cell phone. The MTSO then communicates with the client over a control channel to tell the client or user what frequency channels to use. Once the user phone and its respective cell tower are connected, the call is on between the cell phone and tower via two-way long range RF communication. In the United States, cell phones are assigned frequencies in the 824-894 MHz ranges.

Referring now to FIG. 1, the cellular telecommunications service provider already has the benefit of the cellular wireless telecommunications network infrastructure. Thus, telecommunications service providers set up for the following broadcast feeds from an illustrative one television network broadcast station 28: line-of-sight broadcasts from antenna 33 to antenna 36; a satellite broadcast feed via output dish 29 through an appropriate satellite input dish 45; and a cablevision broadcast feed via cable 35.

Conventionally in the wireless telecommunications system, the wireless telephones and like devices are connected to the PSTN 25 via local switching centers or switching nodes 24 and 26 in a fully wired telecommunications system. Conventionally, these switching nodes 24 and 26 have many telephones connected to each. The centers operate to control the channel connections, i.e. switch into and out of the PSTN 25 those calls originated or terminated at telephone stations 37 or 38. In a similar way, mobile or cellular devices 37 and 38 are connected into the PSTN 30. In the long range RF communication via cell towers 22 or 28, the signals are passed through the respective base stations 23 or 27 to switching centers 24 and 26 that then control the routing of the call to PSTN 25.

Under the control of the service provider 21, the PSTN 25 also has standard access via the Internet or World Wide Web 30 so that all sites on the Internet, e.g. sites 31 and 32, may be accessed through wireless receiver stations 37 and 38.

In accordance with the present invention, which will subsequently be described in greater detail, a subscriber at one of the wireless receiver stations wishes to get broadcast television programming. The receiver station 37 connects with the service provider 21 via the closest cellular tower 22 and base station 23 through PSTN. This sets up an appropriate communication path from the service provider 21 through to the receiver station 37. This includes a dedicated RF channel from tower 22 to the laptop receiver 37. The service provider 21 that is capturing the broadcast programming as previously described, is now enabled to provide the requested broadcast programming to the receiver 37 along the dedicated RF channel.

Since the dedicated channel is two-way, transmit/receive, this arrangement is quite suitable for user-interactive television whereby the user may wish to interact with the television program. For example, if the subscriber is watching a news program that is taking a user poll on a political issue, any interactive response from the user may be transmitted back to the service provider 21 that may then communicate the information back to the broadcasting network. This is advantageous over current listener feedback processes wherein the user has to communicate back with an independently initiated e-mail or like response.

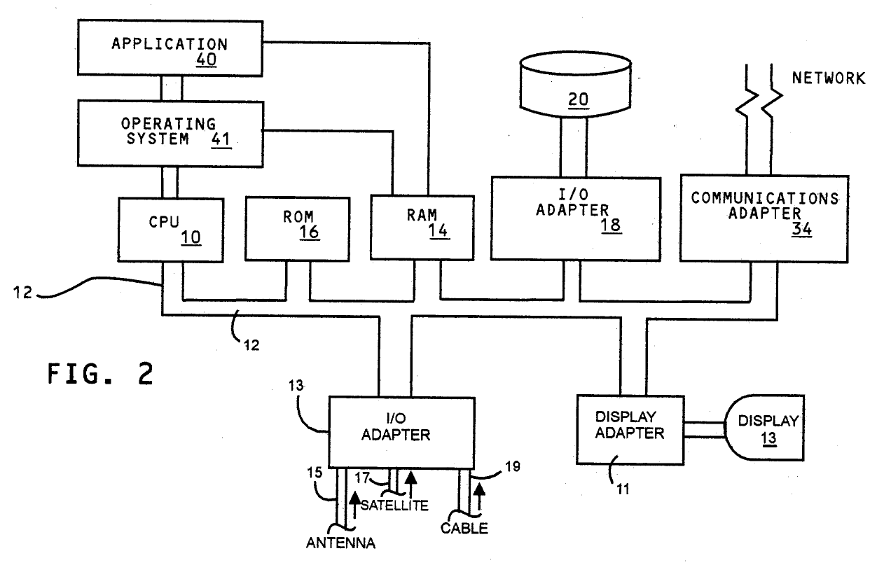

With respect to FIG. 2, there will be described operations involved in the present invention. Such operations at the service provider are controlled by a data processing system under the control of a central processing unit 10, which, in turn, is interconnected to various other components by system bus 12. An operating system 41 that runs on processor 10 provides control and is used to coordinate the functions of the various components of the control system. The OS 41 is stored in Random Access Memory (RAM) 14. The application programs 40 for the functions including those of the present invention are moved into and out of RAM 14 to perform their respective functions. These programs include the programs for distributing broadcast television programming to cellular telecommunications subscribers to be hereinafter described in greater detail. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate over network connections 43 as described with respect to FIG. 1. The various network programming feeds from antennae 15, satellite 17 and cable 19 are connected to system bus 12 via a suitable interface adapter 19. A conventional computer display 13 connected via a display adapter 11 is available for the display of monitoring and control functions. A system like that of FIG. 2 may be used in the wireless laptop receiver 37.

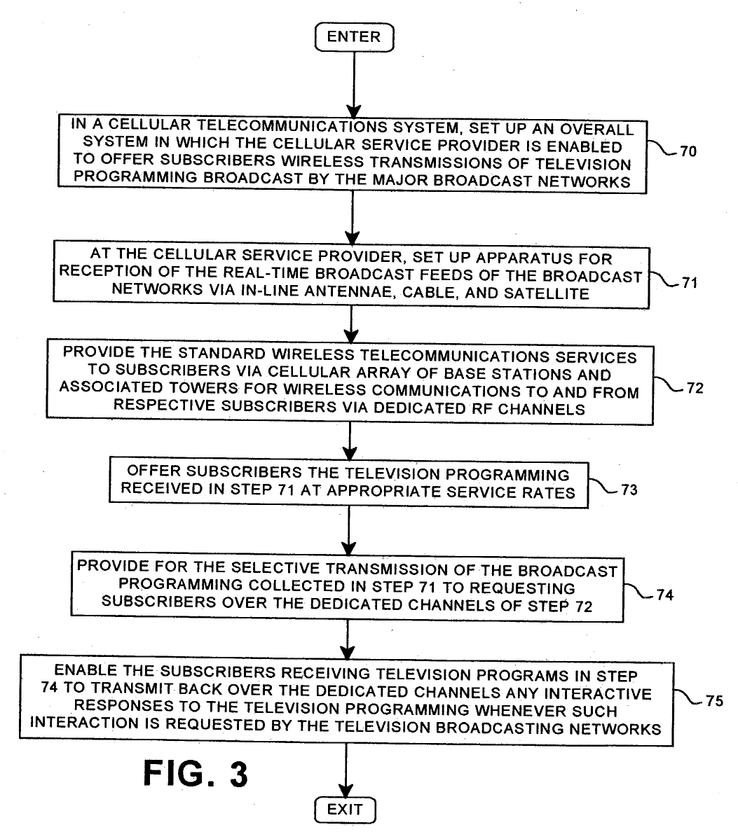

FIG. 3 is a flowchart showing the development of a process according to the present invention for the setting up of a computer programming structure for the distribution of television network broadcast programming to wireless cellular telecommunications subscribers. In a standard cellular telecommunications system, there is set up an overall system in which the cellular service provider is enabled to offer to such subscribers wireless transmissions of television programming broadcast by a plurality of broadcasting networks, step 70. First, step 71, there is set up at the cellular service provider apparatus for the reception of the real-time broadcast feeds of the broadcast networks via antennae, cable and satellite. The cellular provider offers the standard wireless telecommunication services to the subscriber via the conventional cellular array of base stations and associated towers to provide wireless communication to and from receiving subscribers via assigned dedicated RF channels, step 72. In addition, step 73, subscribers are offered the broadcast television programming collected by the service provider in step 71. Then, step 74, the selected transmission of the broadcast programming collected in step 71 is provided to requesting subscribers over channels dedicated in step 72. In addition, step 75, the subscribers receiving the television programs are enabled to transmit back over the dedicated channels any interactive responses to the television programming whenever such interaction is requested by the television broadcasting networks, step 75.

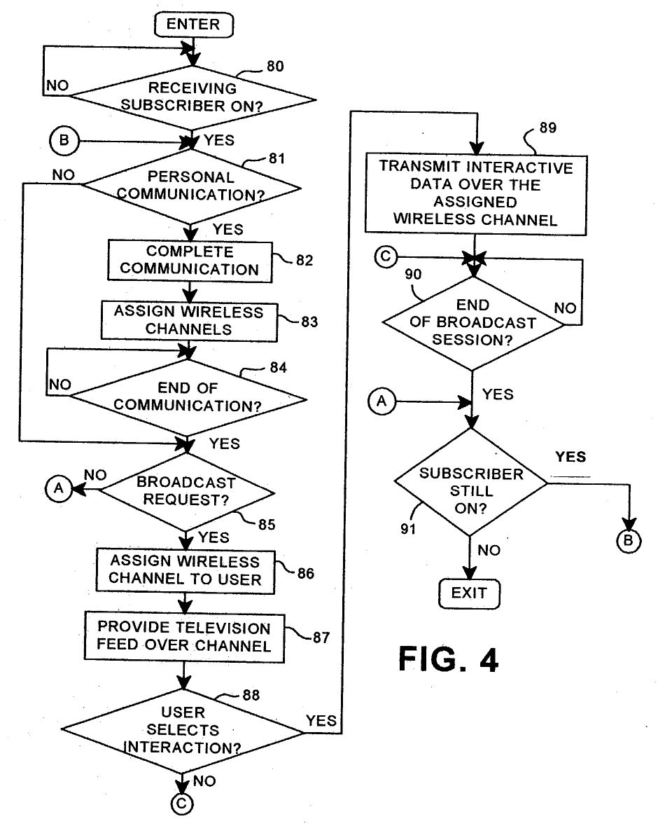

A simplified illustrative running of the process set up in FIG. 3 will now be described with respect to the flowchart of FIG. 4. First, step 80, a turn-on by the receiving subscriber is awaited. If Yes, the receiver is on, a first determination is made as to whether the initial action by the subscriber is for a personal communication, such as a telecommunication, an e-mail or other World Wide Web (Web) communication, step 81. If Yes, the communication is conventionally completed, step 82, with appropriate wireless channels being assigned to cellular telecommunications, step 83. A determination is then made as to whether the telecommunication is ended, step 84. If No, the end of the telecommunication is awaited. If Yes, or if the determination in step 81 had been No, then a determination is made as to whether the subscriber has requested a television broadcast, step 85. If Yes, a wireless RF channel is assigned to the cellular user, step 86, and a television feed of the requested broadcast is provided to the subscriber, step 87. At this point, during the feeding of the requested broadcast, if the broadcast offers user interaction, a determination may be made, step 88, as to whether the subscriber has made an interactive input. If Yes, the interactive data is transmitted over the assigned wireless channel through the service provider and back to the broadcast programming network, step 89. Then, or if the determination in step 88 had been No user interaction (via branch “C”), a determination is made as to whether the broadcast request by the subscriber is at an end, step 90. If No, the end of the broadcast request is awaited. If Yes, or if the determination in step 85 had been No broadcast request (via branch “A”), a determination is made as to whether the subscriber at the receiving point is still turned on, step 91. If No, then the entire session is exited. If Yes, the process is returned to step 81 via branch “B” where the next subscriber action is awaited.

One of the preferred implementations of the present invention is in application program 40 made up of programming steps or instructions resident in RAM 14, FIG. 1, of a Web receiving station and/or Web server during various Web operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Wide Area Network (WAN), such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A communications system for the distribution of broadcast television programming by a cellular telecommunications service provider to a plurality of service subscribers through wireless receivers of said subscribers comprising:
means for broadcasting said television programming;
service provider means for receiving said broadcasted television programming;
cellular service provider means for telecommunicating said television programming to each of said subscribers over a wireless RF channel respectively dedicated to each of said subscribers; and
wireless receiving means at each of said subscribers for receiving said telecommunicated television programming.

2. The telecommunications system of claim 1 wherein said wireless receiving means are mobile receiving means.

3. The telecommunications system of claim 1 wherein said means for telecommunicating television programming transmit said programming in digital form over said wireless RF channel.

4. The telecommunications system of claim 3 further including subscriber interactive means associated with said wireless receiving means for responding to said received television programming over the wireless dedicated channel over which said television programming is transmitted.

5. The telecommunications system of claim 1 further including cellular service provider means for telecommunicating personal subscriber communication to and from said wireless receiving means via said wireless dedicated RF channels.

6. A communications method for the distribution of broadcast television programming by a cellular telecommunications service provider to a plurality of service subscribers through wireless receivers of said subscribers comprising:
broadcasting said television programming;
receiving said broadcasted television programming;
telecommunicating said television programming by a cellular service provider to each of said subscribers over a wireless RF channel respectively dedicated to each of said subscribers; and
wirelessly receiving said telecommunicated television programming at each of said subscribers.

7. The communications method of claim 6 wherein said wireless receiving at each of said subscribers is mobile.

8. The communications method of claim 6 wherein said telecommunicated television programming is transmitted in digital form over said wireless RF channel.

9. The communications method of claim 8 further including the step of enabling said receiving subscribers to interactively respond to said received television programming over the wireless dedicated channel over which said television programming is transmitted.

10. The communications system of claim 6 further including the step of the cellular service provider enabling personal subscriber telecommunications to and from said receiving subscribers via said wireless dedicated RF channels.

11. A computer program having code recorded on a computer readable medium for controlling a communications system for the distribution of broadcast television programming by a cellular telecommunications service provider to a plurality of service subscribers through wireless receivers of said subscribers comprising:
service provider means for receiving said broadcasted television programming;
means for controlling cellular service provider telecommunication of said television programming to each of said subscribers over a wireless RF channel respectively dedicated to each of said subscribers; and
means for controlling wireless receiving means at each of said subscribers for receiving said telecommunicated television programming.

12. The computer program of claim 11 wherein said wireless receiving means are mobile receiving means.

13. The computer program of claim 11 wherein said telecommunication of television programming transmits said programming in digital form over said wireless RF channel.

14. The computer program of claim 13 further including means for controlling subscriber interactive means associated with said wireless receiving means for responding to said received television programming over the wireless dedicated channel over which said television programming is transmitted.

15. The computer program of claim 11 further including cellular service provider means for telecommunicating personal subscriber communications to and from said wireless receiving means via said wireless dedicated RF channels.

16. A communications system for the distribution of broadcast television programming by a cellular telecommunications service provider to a plurality of service subscribers through wireless receivers of said subscribers comprising:
apparatus for broadcasting said television programming;
service provider apparatus for receiving said broadcasted television programming;
cellular service provider apparatus for telecommunicating said television programming to each of said subscribers over a wireless RF channel respectively dedicated to each of said subscribers; and
wireless receiving apparatus at each of said subscribers for receiving said telecommunicated television programming.

17. The telecommunications system of claim 16 wherein said wireless receiving apparatus is mobile.

18. The telecommunications system of claim 16 wherein said apparatus for telecommunicating television programming transmits said programming in digital form over said wireless RF channel.

19. The telecommunications system of claim 18 further including subscriber interactive apparatus associated with said wireless receiving apparatus for responding to said received television programming over the wireless dedicated channel over which said television programming is transmitted.

20. The telecommunications system of claim 16 further including cellular service provider apparatus for telecommunicating personal subscriber communications to and from said wireless receiving apparatus via said wireless dedicated RF channels.
